(19) United States
(12) Patent Application Publication
(10) Pub. No.: US 2008/0010266 A1
(43) Pub. Date: Jan. 10, 2008

(54) A Context-Centric Method of Automated Introduction and Community Building

(76) Inventors: Jonathan F. Brunn, Durham, NC (US); Robert C. Will, Holly Springs, NC (US)

Correspondence Address: HAMILTON & TERRILE, LLP;IBM RSW, P.O. BOX 203518, AUSTIN, TX, 78720, US

(21) Appl. No.: 11/456,243

(22) Filed: Jul. 10, 2006

(51) Int. Cl. G06F 17/30

(52) U.S. Cl. 707/5

(57) ABSTRACT

A method, apparatus and computer-usable medium for discovering groups of users that are distinguished by common views of on-line documents and content items. These common views are analyzed to recommend and facilitate introductions to potential corresponding parties and/or the formation of communities of interest. Users' interactions are logged for a specific task or time period according to predetermined scoping parameters. Accordingly, potential contacts relevant to a current task can be recommended as well as general contact recommendations relevant to interactions over a longer time period. Users can thereby find advisors or mentors for the current task they are performing as well as individuals they may want to contact in general.

### BACKGROUND OF THE INVENTION

1. Field of the Invention

The present invention relates in general to the field of computers and similar technologies, and in particular to software utilized in this field. Still more particularly, the invention relates to automated introduction and community building.

2. Description of the Related Art

The rapid and widespread adoption of on-line computing has facilitated the growth of communities of interest. These groups of individuals share a common interest or identity and are interested in exchanging thoughts and information about their interests, yet they may have little in common otherwise. Furthermore, these communities are often not easily defined by geography, as it is now common for members to communicate and exchange information on a global basis as easily as they once did with their next door neighbor. However, discovering others with similar interests, or even an on-line community of interest itself, can be challenging regardless of whether the interests are personal or professional.

For example, in many large enterprises there are individuals who work with the same technologies or in the same market sectors yet they are unaware of each other. Gaining awareness of others with similar interests or needs has historically placed the burden on the individual to be proactive in joining industry or user groups, subscribing to on-line forums, participating in corporate or association teamrooms, or compiling descriptive personal profiles. While some of these approaches provide search capabilities to find others with a similar interest profile, the respective interests of each individual are not automatically determined and categorized. Instead, not only must the user explicitly describe and state his or her interests, but other users with matching profiles are not automatically recommended. Additionally, the search is conducted proactively, resulting in subject matter experts and interested parties not being brought together automatically.

Furthermore, without a predefined taxonomy, each individual may use different descriptor tags when classifying areas of interest, potentially causing mismatches or no match at all. In view of the foregoing, there is a need for identifying users with similar interests or needs through an automated “discovery of commonality” and then facilitating introductions to each other.

### SUMMARY OF THE INVENTION

The present invention includes, but is not limited to, a method, apparatus and computer-usable medium for discovering groups of users that are distinguished by common views of on-line documents and content items. These common views can be analyzed to recommend and facilitate introductions to potential corresponding parties and the formation of communities of interest. Using a recommendation platform, such as the LikeMinds recommendation platform produced by IBM Corporation, and known data mining approaches, users' interactions are logged for a specific task or time period according to predetermined scoping parameters. Accordingly, potential contacts relevant to a current task can be recommended as well as general contact recommendations relevant to interactions over a longer time period. Users can thus find advisors or mentors for the current task they are performing as well as individuals they may want to contact in general.

For example, a user who is currently working on a technical design document may have a short term interest in meeting others who have drafted technical designs documents. However, if the user rarely drafts design documents, specialists in design documents may not show up in their general recommendations for contact. In another embodiment of the invention, a community of interest is automatically created once a predetermined number of users matching a common area of content are discovered. As an example, a community of technical design authors would be suggested when a predetermined number of users are detected matching this relationship.

In various embodiments of the invention, one or more platforms such as, but not limited to, Web Content Management, Document Management, and Teamroom are integrated to capture information regarding user content views. In other embodiments of the invention, a portlet is implemented, which makes contact recommendations to the users and allows them to act on recommendations by sending emails, initiating a chat session, or adding recommended users to their contact list. The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary client computer in which the present invention may be implemented;

FIG. 2 illustrates an exemplary server from which software for executing the present invention may be deployed and/or implemented for the benefit of a user of the client computer shown in FIG. 3;

FIG. 3 is a generalized block diagram of a recommendation system in accordance with an embodiment of the invention;

FIG. 4 is a generalized depiction of the operation of the recommendation system implemented to identify two or more users that are unaware they share similar interests;

FIGS. 5a-b show a flow-chart of steps taken to deploy software capable of executing the steps shown and described in FIG. 3;

FIGS. 6a-c show a flow-chart of steps taken to deploy in a Virtual Private Network (VPN) software that is capable of executing the steps shown and described in FIG. 3;

FIGS. 7a-b show a flow-chart showing steps taken to integrate into a computer system software that is capable of executing the steps shown and described in FIG. 3; and

FIGS. 8a-b show a flow-chart showing steps taken to execute the steps shown and described in FIG. 3 using an on-demand service provider.

### DETAILED DESCRIPTION

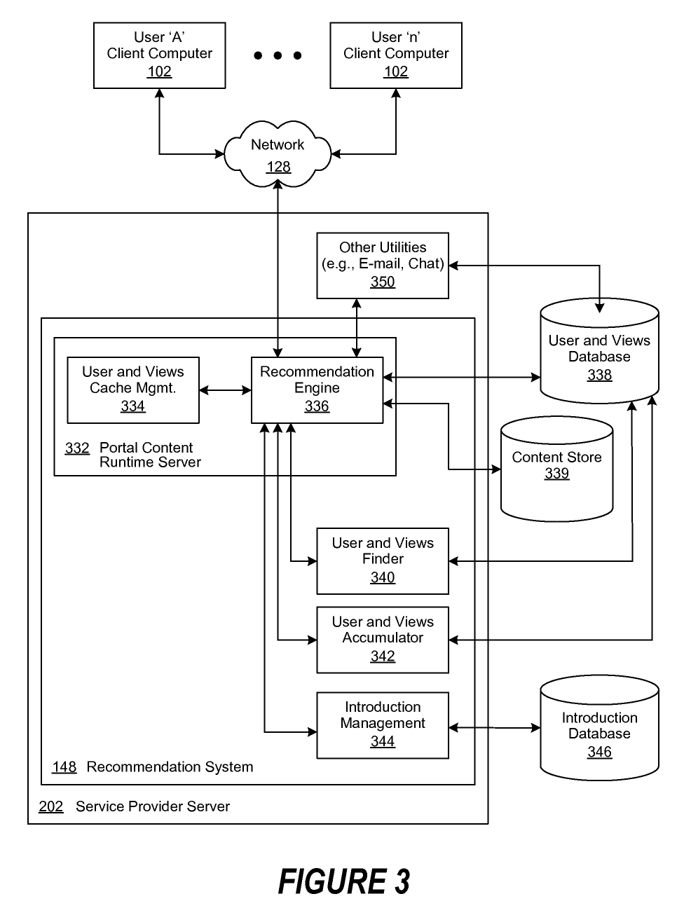

With reference now to the figures, and in particular to FIG. 3, there is depicted a method, apparatus and computer-usable medium for discovering groups of users that are distinguished by common views of on-line documents and content items to recommend and facilitate introductions or form communities of interest.

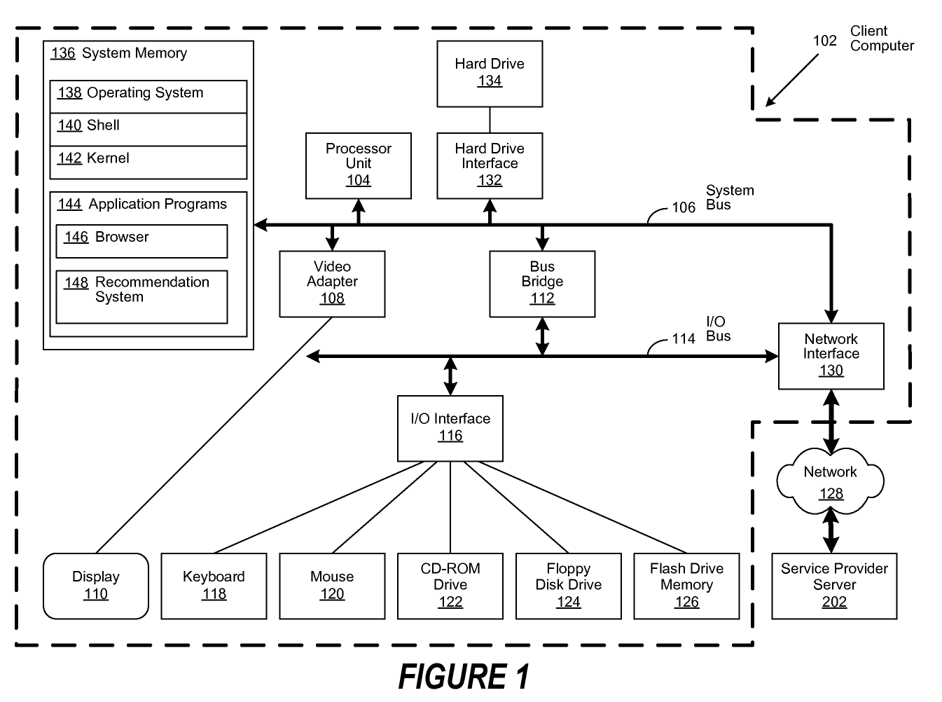

With reference now to FIG. 1, there is depicted a block diagram of an exemplary client computer 102, in which the present invention may be utilized. Client computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 416 may be any known to those skilled in the art of computer architecture, including but not limited to Universal Serial Bus (USB) ports.

Client computer 102 is able to communicate with a service provider server 202 via a network 128 using a network interface 130, which is coupled to system bus 106. Network 128 may be an external network such as the Internet, or an internal network such as an Ethernet or a Virtual Private Network (VPN). Using network 128, client computer 102 is able to use the present invention to access service provider server 202.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 202.

Application programs 144 in client computer 102's system memory also include some or all of a recommendation system 148. The recommendation system 148 includes code for implementing the processes described in FIG. 3. In one embodiment, client computer 102 is able to download the recommendation system 148 from service provider server 202. Because of the collaborative nature of the recommendation engine 148, it tracks patters of usage across multiple users (and most likely multiple clients). Accordingly, even if the recommendation engine 148 is on the client computer 102, it communicates with a database server over the network (via some direct protocol like JDBC or ODBC or via an indirect connection like web services) or with some distributed peer-to-peer (P2P) system over which logged content views can be gathered.

The hardware elements depicted in client computer 102 are not intended to be exhaustive, but rather are representative to highlight essential components required by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

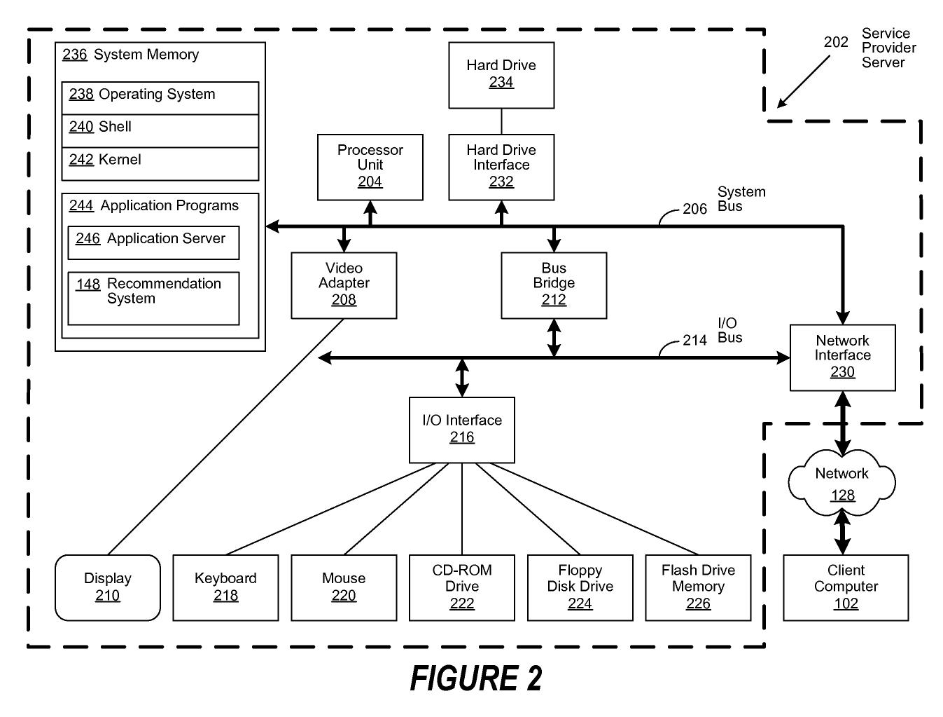

As noted above, the recommendation system 148 can be downloaded to client computer 202 from service provider server 202, shown in exemplary form in FIG. 2. Service provider server 202 includes a processor unit 204 that is coupled to a system bus 206. A video adapter 208 is also coupled to system bus 206. Video adapter 208 drives/supports a display 210. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Service provider server 202 is able to communicate with client computer 102 via network 128 using a network interface 230, which is coupled to system bus 206. Access to network 128 allows service provider server 202 to execute and/or download the recommendation system 148 to client computer 102.

System bus 206 is also coupled to a hard drive interface 232, which interfaces with a hard drive 234. In a preferred embodiment, hard drive 234 populates a system memory 236, which is also coupled to system bus 206. Data that populates system memory 236 includes service provider server 202's operating system 238, which includes a shell 240 and a kernel 242. Shell 240 is incorporated in a higher level operating system layer and utilized for providing transparent user access to resources such as application programs 244, which include an application server 246, and a copy of the recommendation system 148 described above, which can be deployed to client computer 102.

The hardware elements depicted in service provider server 202 are not intended to be exhaustive, but rather are representative to highlight essential components required by the present invention. For instance, service provider server 202 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 202 performs all of the functions associated with the present invention (including execution of the recommendation system 148), thus freeing client computer 102 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Referring to FIG. 3, a block diagram of a recommendation system is shown. The present invention comprises content view events. Content view events are automatically logged by, for example, a Portal Document Manager application, Web Content Management application and Teamrooms platforms. Action events are non-view actions enacted upon a document or content item. Common action events include authoring, bookmarking, e-mailing, sending a link, commenting on, or approving (e.g., as in a workflow approval process. Users may be assigned a unique identifier (ID) and similarly, each document or discrete content item includes a unique identifier, which is logged with the user ID whenever the document or content is viewed. Correlations can then be made between two or more users viewing one or more common documents or content items. A recommendation engine, such as the LikeMinds recommendation engine produced by IBM Corporation, groups users by the similarity of their actions. For example, similar events can be classified, such as content views and other actions on documents and content items. The recommendation engine gives extra weight to the relationship between a user and the content upon which the user acts. That is, it is assumed the user has a higher affinity toward that document or content item.

Recommendation system 148 maintains a record of content viewed and actions taken within different scopes. For example, a user scope encompasses a user's total viewing and action history, while a session scope is bounded by a user's views and actions within a predetermined time interval, and a task scope is bounded by a user's interactions relative to an associated task in a workflow system. While global scope encompasses all interactions in all other scopes, tasks and sessions are orthogonal. Tasks may span multiple sessions and a single session may include parts of multiple tasks. Session scope is used in place of task scope when a workflow system is unavailable to group a user's work associated with one or more tasks within a predetermined session. Given that session scope and task scope are both intended to determine what the user is working on at a predetermined time, task scope can be used to include both, unless a workflow system is unavailable, at which time session scope may be substituted for task scope.

Scoping is extensible, with new scopes defined by implementing a programming interface. For example, a last three months scope can be applied to the content views currently under analysis, allowing the capture of recent trends, such as when a user changes tasks or begins working on a new project, resulting in relevant contact recommendations being provided to the user. As an example, while a user might be globally associated with users of a WebSphere Portal and Portal Personalization, the user may have a session or task where their content views suggest current affinity toward users of auto-classification tools and experts in the area of collaborative filtering, and more specifically, users who submitted disclosures in this area. Accordingly, recommendations can be generated for the current session or task, suggesting that the user might be interested in collaborating with subject matter experts in areas where they are not an expert, or likewise, when their total user history indicates no past affinity for relevant subject areas.

Similarly, a plurality of introduction associations can be defined, such as task-to-task, which is used to identify similarities between tasks by looking for common elements in documents and content items viewed by participants in two or more tasks. When access controls permit, users are shown other users who participated in similar tasks, whether completed or in progress. Individuals who worked on similar tasks in the past may serve as advisors or mentors, resulting in the initiation of an introduction between the possible mentor and the current user. A task-to-user introduction association is used to find other users who are experts or generally interested in a user's current task by looking for similarities in the documents and content items viewed by a participant in a task and the overall viewing history of another user. The other user might not have performed a similar task before, but their area of expertise will generally be relevant to the task or they have indicated interest in the task that is being performed. Similarly, a user-to-user introduction association is used to build communities by matching two or more users, based on similarities between their overall viewing and action history. For example, sales associates who specialize in the same product line can build a community to assist each other in achieving their common goals.

A portlet is implemented to provide introduction recommendations by acting as a dynamic contact list, recommending users with similar affinity to the same documents and content items as the current user. Logged events are analyzed using recommendation platforms such as the LikeMinds recommendation platform and traditional data mining, resulting in users with similar logged events being introduced. Users are provided with two tabbed sections in a portlet. One tab in the portlet recommends introductions based on task (task-to-task to task-to-user) associations and another based on user (user-to-user) associations. The portlet may utilize capabilities of other platforms, such as a WebSphere Portal available from IBM Corporation, such that a user can click on the introduced contact and initiate a chat session, send an e-mail, or add the introduced contact to their contact list. If a user performs such an action on the contact, then it is registered as accepted. A user may also remove an introduced contact from the portlet and the recommendation will be registered as “declined” unless a prior action was performed on the contact.

In a different embodiment of the invention, an Application Program Interface is implemented to obtain lists of recommended contacts and to accept or deny contacts, thereby allowing integration into existing contact list portlets, teamrooms, and other tools. The API can be further implemented to recommend teamroom participants by logging all teamroom documents as having been viewed by a virtual user. As a result, users who show an affinity toward content in the teamroom can be identified and recommended to the teamroom owner through an e-mail.

Introductions are not made based on foreknowledge of individual users, but rather, on logged data corresponding to their respective document and content item views. For example, the introduction recommendation system 148 does not know if two users are similar because they share an interest in Sarbanes-Oxley regulatory compliance, sales of WebSphere Portal, IT security policy management, all of the preceding, or something else entirely. However, a recommendation for an introduction recommendation system 148 can be made because their common document and content item views indicate they share an interest in all of these topics.

If many documents or content item views are involved in the recommendation and few of them are in a common category, the introduction recommendation system 148 can traverse the category hierarchy until a commonality is found between two or more of the documents or content items. This navigation of the category hierarchy can be performed until the introduction recommendation system 148 narrows the relationship to a predetermined, smaller number (e.g., 5-10) of categories that are common or a likewise predetermined, smaller number of categories that contain a predetermined number of shared content views.

An introduction can be made to two users that are unaware they share a common interest. A user has an interest in a subject area and is interested in identifying others with the same interest. The introduction recommendation system 148 performs a search on a content management system, such as the Java Content Repository of a WebSphere Portal, produced by IBM Corporation, comparing the user's document and content item views to those of other users.

In one embodiment, as common views are discovered, the classification or categorization associated with the content to which the view is associated is used to identify association between users. Instead of placing the burden on individual users to categorize themselves, the introduction recommendation system 148 relies on a content management system to correctly categorize documents and content items viewed by users. Based on classification and/or category matches, introduction recommendations are generated and user IDs are translated into people-aware links, such as to chat or e-mail applications that can be clicked-on to connect users sharing an interest in the aforementioned subject area.

Acceptance of a recommended introduction contact is signified by adding the recommended contact to a contact list or by initiating communication with the contact. When a predetermined number of users have accepted relationships identified by the same category or set of categories, a new community is recommended. For example, in the Lotus Workplace application available from IBM Corporation, a new teamroom is automatically created and invitations are sent to all users with a recommended relationship tagged by a shared identifier. In an embodiment of the invention, the threshold number of users to trigger this action is predetermined. In another embodiment of the invention, a community is automatically created when a predetermined number of users are identified that share a common interest defined by their respective document and content item views.

Content clustering is implemented to increase the number of potential introduction contact recommendations by identifying document or content item views that may not be an exact match of a user's views, but are close or similar. The recommendation system may cluster documents or content items that appear in the same tasks together frequently, with other forms of clustering considered auto-categorization. A plurality of known clustering techniques may be implemented, ranging from simple manual categorization of content within a content repository to complex data analysis such as Latent Semantic indexing of content, or implementation of the LikeMinds recommendation platform itself. Accordingly, improved contact recommendations can be provided with fewer recorded user interactions, as searches are not constrained to users who viewed the same documents or content items, but extended to include users that viewed content in the same cluster groupings.

Introduction participation can be made voluntary by providing users the ability to stop the introduction recommendation system 148 from recording their actions for a predetermined time interval. For example, an icon can be implemented indicating whether the introduction recommendation system is currently recording actions or views. Clicking this icon toggles the introduction recommendation system 148 on and off for that user, with the appearance of the icon changing so the user knows whether their actions or views are being recorded. However, even if the introduction recommendation system 148 is not currently recording actions and views, it is still able to propose introductions based on information it has already collected.

Introduction recommendation system 148 allows a user to go into an invisible or stealth mode, where other users will not be sent introductions, yet introduction recommendations can still be received, such as through a portlet page. Similarly, users may also opt-out of the community organization features, separately from the introduction contact recommendation feature. The recommendation system can likewise be configured to not allow use of any recommendations unless the user if visible, thereby motivating active user participation and reducing the number of quiet participants. Furthermore, the user's privacy can be ensured as they control whether or when action and viewing data is logged, as well as when recommendations of their contact information can be made.

Referring now to FIG. 3, a generalized block diagram of an implementation of the recommendation system is depicted in accordance with an embodiment of the invention. User A client computer 102 through user ‘n’ client computer 102 connects through network 128 to service provider server 202 as described in greater detail hereinabove. Service provider server 202 comprises the recommendation system 148 and other utilities 350, such as, but not limited to, e-mail, chat, and other applications.

Introduction recommendation system 148 comprises portal content run-time server 332, user and views finder 340, user and views accumulator 342, and introduction, management 344. Portal content runtime server 332 comprises user and views cache management 334 and recommendation engine 336. Recommendation engine 336, such as the LikeMinds recommendation engine available from IBM Corporation, is coupled to user and views database 338 and a content store 339, as well as user and views cache management 334. User and views finder 340 searches user and views database 338 to identify two or more users' common views of on-line documents and content items, which are collected in user and view accumulator 342 for processing by recommendation engine 336. The content store 339 may include a relational or hierarchical database, a file system, a content repository or some other service which provides content.

Recommendation engine 336 is coupled to introduction management 344, which in turn is coupled to introduction database 346. Recommendations engine 336 produces candidate contact recommendations, which are bounded by introduction management 344, which references introduction database 346 for associated action, scope, association, community, and permissions parameters. If pre-existing bounds are present, they are applied to the candidate contact recommendation. If no pre-existing bounds are present, the introduction contact recommendation is stored in introduction database 346. The resulting introduction contact recommendation is then conveyed by recommendation engine 336 via network 128 to its predetermined user destination, user A client computer 102 through user ‘n’ client computer 102.

Associated scope, action, association, community and permissions parameters, as stored in database 346 and administered by introduction management 344, bound introduction contact recommendations, their behavior, and associated actions as described in greater detail hereinabove. Other utilities 350, such as, but not limited to email, chat and contact applications can be invoked either by the recommendation system 148 or user A 102 through user ‘n’ 102 to establish links to or between identified users sharing similar interests or needs.

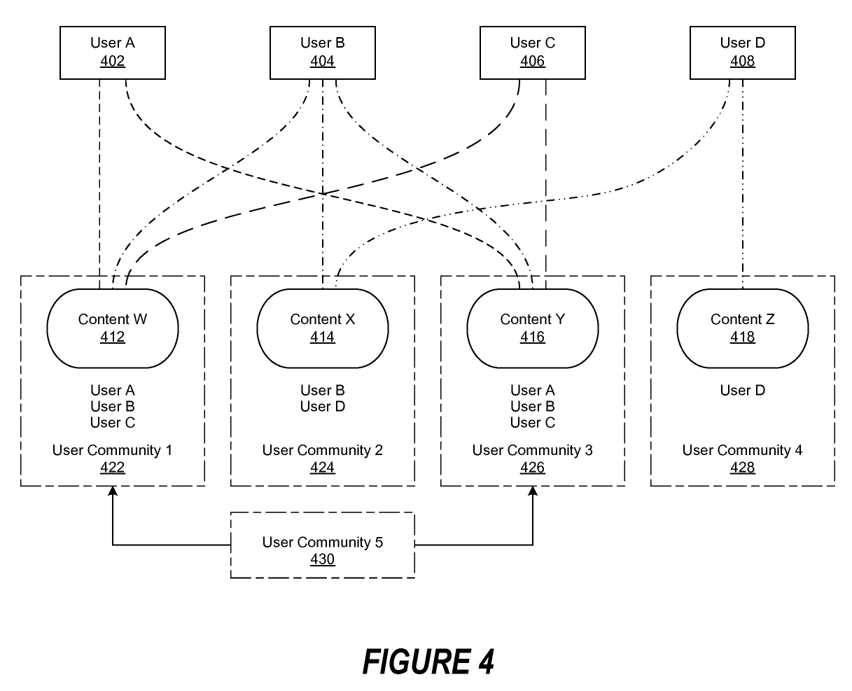

FIG. 4 is a generalized depiction of the operation of the recommendation system implemented to identify two or more users that are unaware they share similar interests. More specifically, user A 402, user B 404, user C 406 and user D 408 have access to a body of on-line content, comprising content W 412, content X 414, content Y 416 and content Z 418. Introduction recommendation system 148 captures and analyzes user views of content to identify users that share similar interests but may be unaware of each other. The generalized depiction is illustrative, though not necessarily comprehensive. For example, shared views may not be on the same pieces of content necessarily, but may be on two pieces of content decided to be similar by some other mechanism. Two users may not even share any views, but be grouped into a community because of views both those users shared with a third user.

For example, content W 412 is viewed by user A 402, user B 404, and user C 406, signifying they share a common interest in content W 412, and as such, receives a recommendation to contact each other from the recommendation system 148. Similarly, content X 414 is viewed by user B 404, and user D 408, signifying they share a common interest in content X 414, and as such, receive a recommendation to contact each other from the recommendation system 148. Likewise, content Y 416 is viewed by user A 402, user B 404, and user C 406, signifying they share a common interest in content Y 416, and as such, receives a recommendation to contact each other from the recommendation system 148. However, content Z 418 is viewed only by user D 408, signifying that no other users share a common interest in content Z 418, resulting in no contact recommendations being generated by the recommendation system 148.

The introduction recommendation system 148 enables communities of interest to be formed automatically, by extending invitations to users with similar interests to join. For example, user community 1 422, comprising user A 402, user B 404, and user C 406, can be formed due to their mutual interest in content W 412. Similarly, user community 2 424, comprising user B 404, and user D 408, can be formed due to their mutual interest in content X 414. Likewise, user community 3 426, comprising user A 402, user B 404, and user C 406, can be formed due to their mutual interest in content Y 416. However, no user community 4 428 is formed, as only user D 408 is interested in content Z 428. By extension, user community 5 430, comprising user A 402, user B 404, and user C 406, can be formed due to their mutual interest in both content W 412 and content Y 416.

Thus, the method described herein, and in particular as shown and described in FIG. 3, can be deployed as a process software from service provider server 202 to client computer 102.

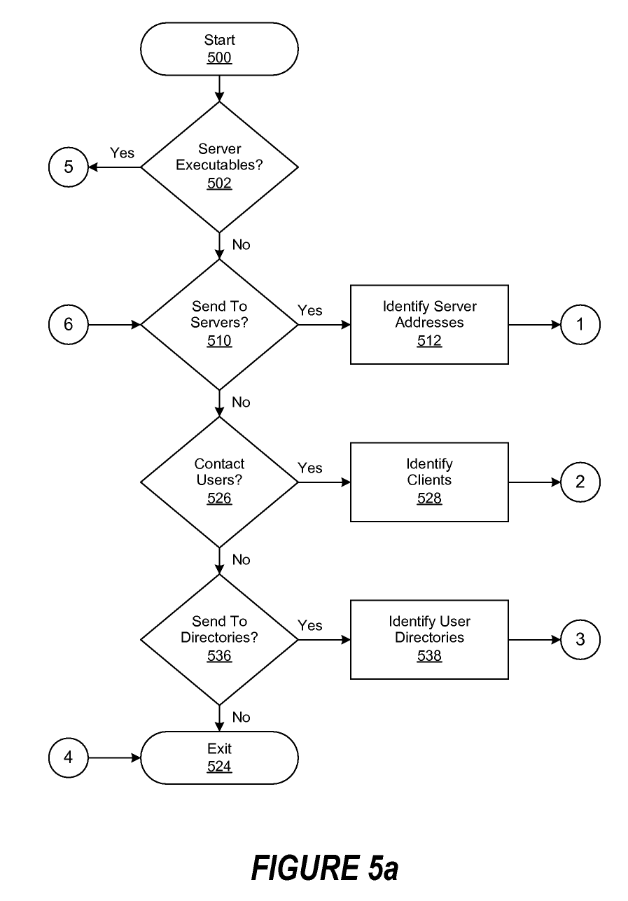

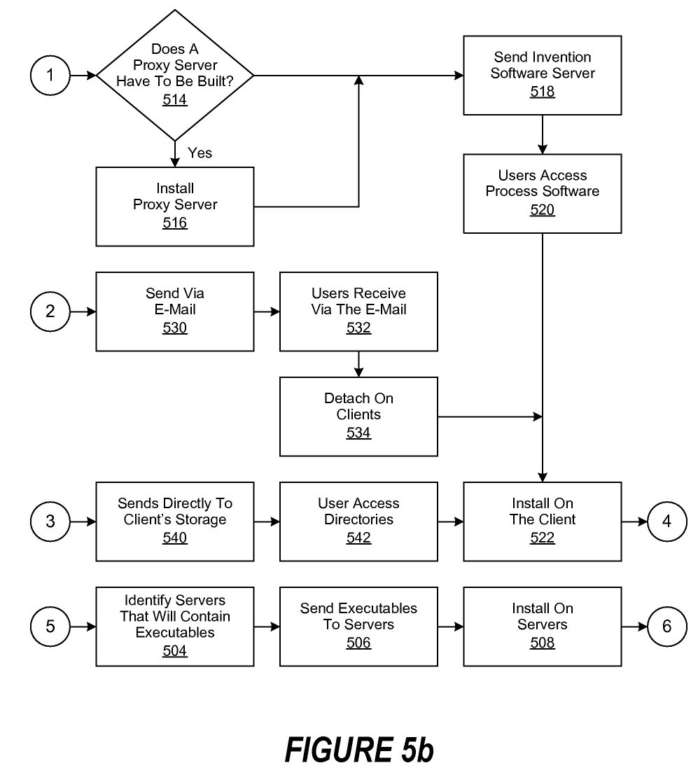

Referring then to FIG. 5, step 500 begins the deployment of the process software. The first thing is to determine if there are any programs that will reside on a server or servers when the process software is executed (query block 502). If this is the case, then the servers that will contain the executables are identified (block 504). The process software for the server or servers is transferred directly to the servers' storage via File Transfer Protocol (FTP) or some other protocol or by copying though the use of a shared file system (block 506). The process software is then installed on the servers (block 508).

Next, a determination is made on whether the process software is to be deployed by having users access the process software on a server or servers (query block 510). If the users are to access the process software on servers, then the server addresses that will store the process software are identified (block 512).

A determination is made if a proxy server is to be built (query block 514) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 516). The process software is sent to the servers either via a protocol such as FTP or it is copied directly from the source files to the server files via file sharing (block 518). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 520). Another embodiment is to have the servers automatically copy the process software to each client and then run the installation program for the process software at each client computer. The user executes the program that installs the process software on his client computer (block 522) then exits the process (terminator block 524).

In query step 526, a determination is made whether the process software is to be deployed by sending the process software to users via e-mail. The set of users where the process software will be deployed are identified together with the addresses of the user client computers (block 528). The process software is sent via e-mail to each of the users' client computers (block 530). The users then receive the e-mail (block 532) and then detach the process software from the e-mail to a directory on their client computers (block 534). The user executes the program that installs the process software on his client computer (block 522) then exits the process (terminator block 524).

Lastly a determination is made on whether to the process software will be sent directly to user directories on their client computers (query block 536). If so, the user directories are identified (block 538). The process software is transferred directly to the user's client computer directory (block 540). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 542). The user executes the program that installs the process software on his client computer (block 522) and then exits the process (terminator block 524).

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

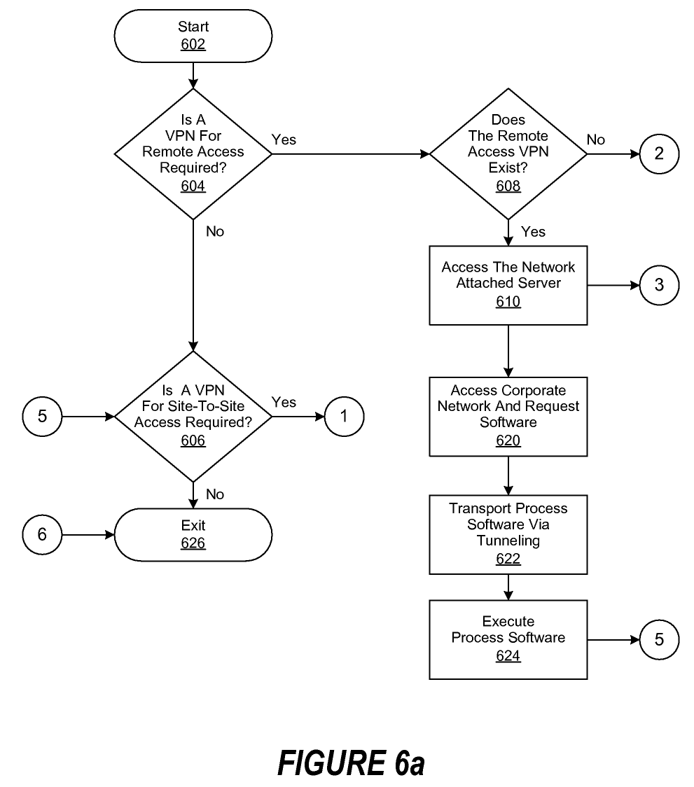

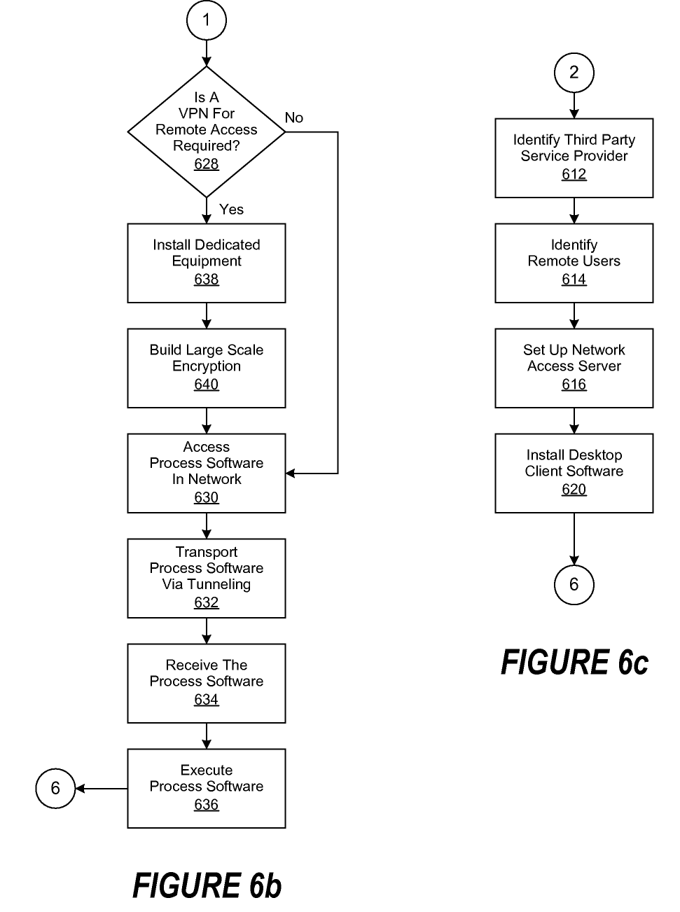

The process for such VPN deployment is described in FIG. 6. Initiator block 602 begins the Virtual Private Network (VPN) process. A determination is made to see if a VPN for remote access is required (query block 604). If it is not required, then proceed to query block 606. If it is required, then determine if the remote access VPN exists (query block 608).

If a VPN does exist, then proceed to block 610. Otherwise identify a third party provider that will provide the secure, encrypted connections between the company's private network and the company's remote users (block 612). The company's remote users are identified (block 614). The third party provider then sets up a network access server (NAS) (block 616) that allows the remote users to dial a toll free number or attach directly via a broadband modem to access, download and install the desktop client software for the remote-access VPN (block 618).

After the remote access VPN has been built or if it been previously installed, the remote users can access the process software by dialing into the NAS or attaching directly via a cable or DSL modem into the NAS (block 610). This allows entry into the corporate network where the process software is accessed (block 620). The process software is transported to the remote user's desktop over the network via tunneling. That is, the process software is divided into packets and each packet including the data and protocol is placed within another packet (block 622). When the process software arrives at the remote user's desktop, it is removed from the packets, reconstituted and then is executed on the remote user's desktop (block 624).

A determination is then made to see if a VPN for site to site access is required (query block 606). If it is not required, then proceed to exit the process (terminator block 626). Otherwise, determine if the site to site VPN exists (query block 628). If it does not exist, then proceed to block 630. Otherwise, install the dedicated equipment required to establish a site to site VPN (block 638). Then build the large scale encryption into the VPN (block 640).

After the site to site VPN has been built or if it had been previously established, the users access the process software via the VPN (block 630). The process software is transported to the site users over the network via tunneling (block 632). That is the process software is divided into packets and each packet including the data and protocol is placed within another packet (block 634). When the process software arrives at the remote user's desktop, it is removed from the packets, reconstituted and is executed on the site user's desktop (block 636). The process then ends at terminator block 626.

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

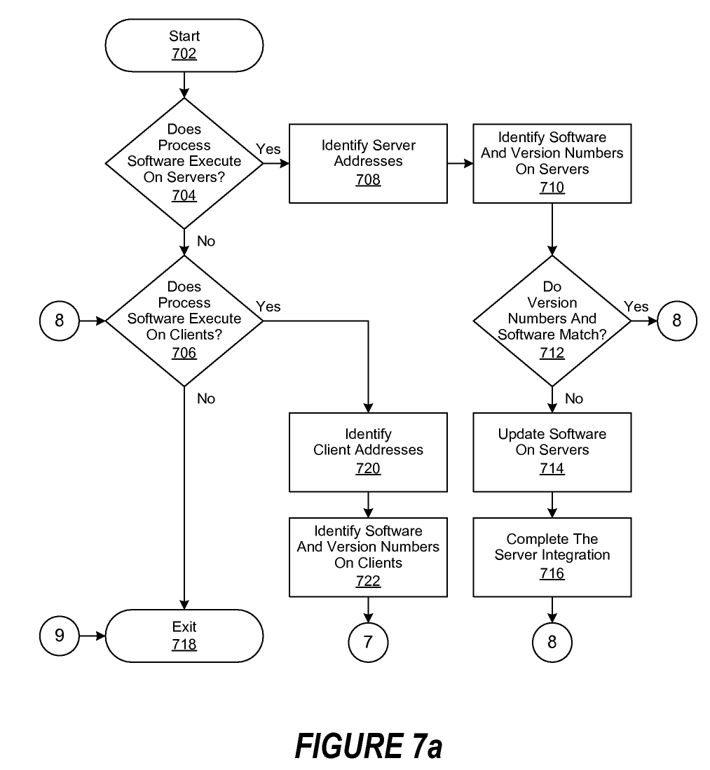

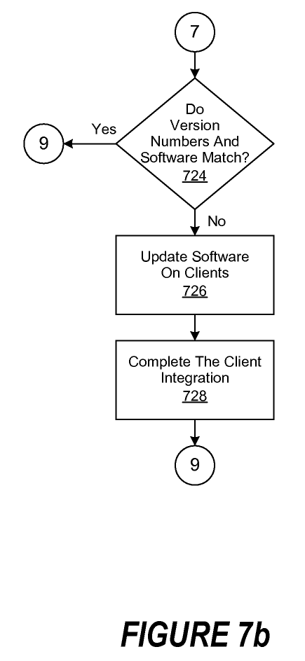

For a high-level description of this process, reference is now made to FIG. 7. Initiator block 702 begins the integration of the process software. The first tiling is to determine if there are any process software programs that will execute on a server or servers (block 7). If this is not the case, then integration proceeds to query block 706. If this is the case, then the server addresses are identified (block 708). The servers are checked to see if they contain software that includes the operating system (OS), applications, and network operating systems (NOS), together with their version numbers, which have been tested with the process software (block 710). The servers are also checked to determine if there is any missing software that is required by the process software in block 710.

A determination is made if the version numbers match the version numbers of OS, applications and NOS that have been tested with the process software (block 712). If all of the versions match and there is no missing required software the integration continues in query block 706.

If one or more of the version numbers do not match, then the unmatched versions are updated on the server or servers with the correct versions (block 714). Additionally, if there is missing required software, then it is updated on the server or servers in the step shown in block 714. The server integration is completed by installing the process software (block 716).

The step shown in query block 706, which follows either the steps shown in block 704, 712 or 716 determines if there are any programs of the process software that will execute on the clients. If no process software programs execute on the clients the integration proceeds to terminator block 718 and exits. If this not the case, then the client addresses are identified as shown in block 720.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 722.

A determination is made is the version numbers match the version numbers of OS, applications and NOS that have been tested with the process software (query block 724). If all of the versions match and there is no missing required software, then the integration proceeds to terminator block 718 and exits.

If one or more of the version numbers do not match, then the unmatched versions are updated on the clients with the correct versions (block 726). In addition, if there is missing required software then it is updated on the clients (also block 726). The client integration is completed by installing the process software on the clients (block 728). The integration proceeds to terminator block 718 and exits.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

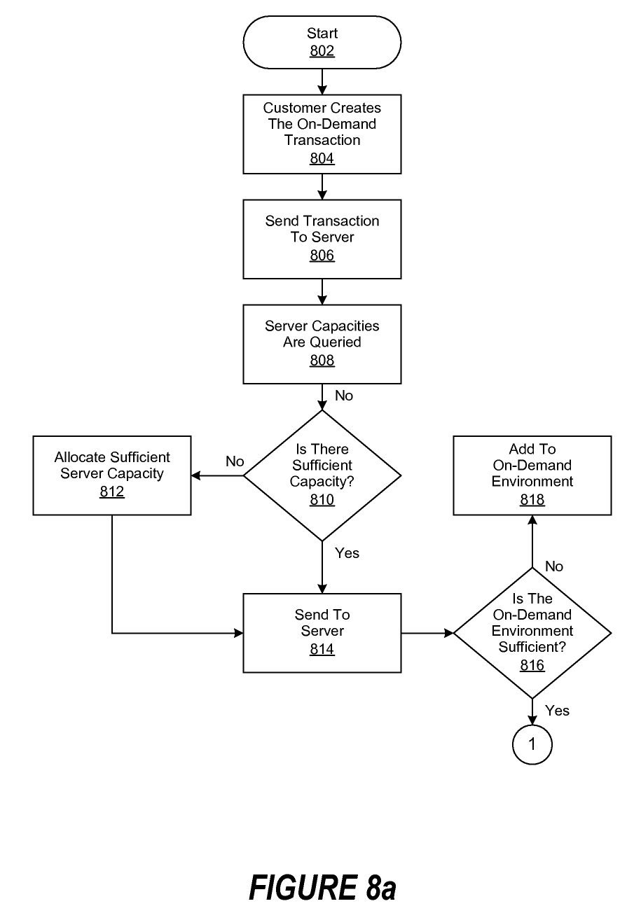

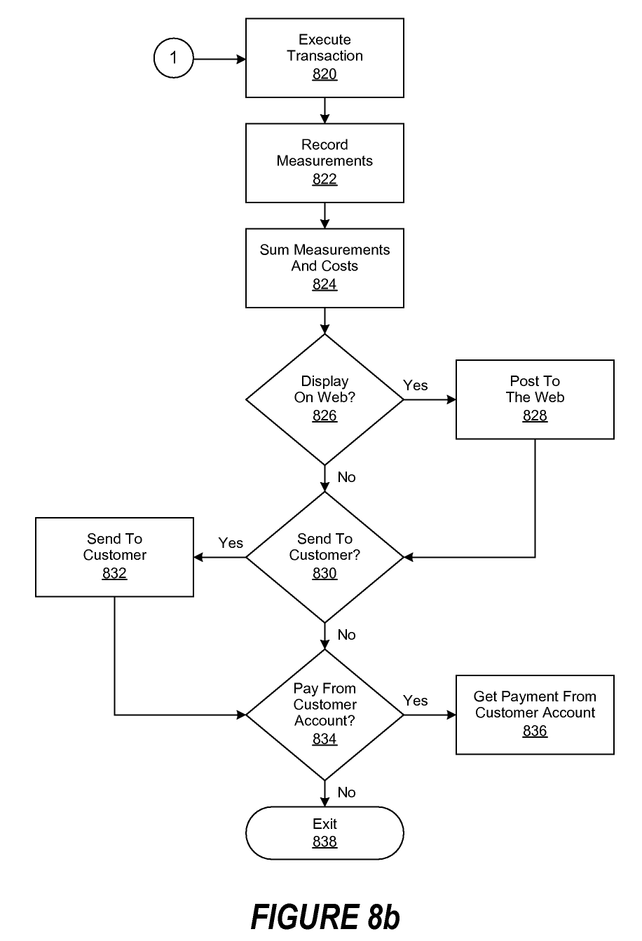

With reference now to FIG. 8, initiator block 802 begins the On Demand process. A transaction is created than contains the unique customer identification, the requested service type and any service parameters that further, specify the type of service (block 804). The transaction is then sent to the main server (block 806). In an On Demand environment the main server can initially be the only server, then as capacity is consumed other servers are added to the On Demand environment.

The server central processing unit (CPU) capacities in the On Demand environment are queried (block 808). The CPU requirement of the transaction is estimated, then the servers available CPU capacity in the On Demand environment are compared to the transaction CPU requirement to see if there is sufficient CPU available capacity in any server to process the transaction (query block 810). If there is not sufficient server CPU available capacity, then additional server CPU capacity is allocated to process the transaction (block 812). If there was already sufficient available CPU capacity then the transaction is sent to a selected server (block 814).

Before executing the transaction, a check is made of the remaining On Demand environment to determine if the environment has sufficient available capacity for processing the transaction. This environment capacity consists of such things as but not limited to network bandwidth, processor memory, storage etc. (block 816). If there is not sufficient available capacity, then capacity will be added to the On Demand environment (block 818). Next the required software to process the transaction is accessed, loaded into memory, then the transaction is executed (block 820).

The usage measurements are recorded (block 822). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 824).

If the customer has requested that the On Demand costs be posted to a web site (query block 826), then they are posted (block 828). If the customer has requested that the On Demand costs be sent via e-mail to a customer address (query block 830), then these costs are sent to the customer (block 832). If the customer has requested that the On Demand costs be paid directly from a customer account (query block 834), then payment is received directly from the customer account (block 836). The On Demand process is then exited at terminator block 838.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method comprising:
monitoring when a user accesses content; and,
analyzing the accesses to recommend and facilitate introductions to other users who have accessed similar content.

2. The computer-implementable method of claim 1 further comprising:
automatically forming a community relating to the similar content when multiple users access the similar content.

3. The computer-implementable method of claim 1 wherein:
the analyzing if performed via a recommendation platform.

4. The computer-implementable method of claim 1 wherein:
the recommendation platform includes the LikeMinds recommendation platform.

5. The computer-implementable method of claim 1 wherein:
the monitoring when a user accesses content includes logging user interaction for a specific task or time period according to predetermined scoping parameters.

6. The computer-implementable method of claim 1 wherein:
potential contacts relevant to a current task are recommended as well as general contact recommendations relevant to the content.

7. A system comprising:
a processor;
a data bus coupled to the processor; and
a computer-usable medium embodying computer program code, the computer-usable medium being coupled to the data bus, the computer program code comprising instructions executable by the processor and configured for:
monitoring when a user accesses content; and,
analyzing the accesses to recommend and facilitate introductions to other users who have accessed similar content.

8. The system of claim 7, wherein the instructions are further configured for:
automatically forming a community relating to the similar content when multiple users access the similar content.

9. The system of claim 7, wherein:
the analyzing if performed via a recommendation platform.

10. The system of claim 7, wherein:
the recommendation platform includes the LikeMinds recommendation platform.

11. The system of claim 7, wherein:
the monitoring when a user accesses content includes logging user interaction for a specific task or time period according to predetermined scoping parameters.

12. The system of claim 7, wherein:
potential contacts relevant to a current task are recommended as well as general contact recommendations relevant to the content.

13. A computer-usable medium embodying computer program code, the computer program code comprising computer executable instructions configured for:
monitoring when a user accesses content; and,
analyzing the accesses to recommend and facilitate introductions to other users who have accessed similar content.

14. The computer-usable medium of claim 13, wherein the embodied computer program code further comprises computer executable instructions configured for:
automatically forming a community relating to the similar content when multiple users access the similar content.

15. The computer-usable medium of claim 13, wherein:
the analyzing if performed via a recommendation platform.

16. The computer-usable medium of claim 13, wherein:
the recommendation platform includes the LikeMinds recommendation platform.

17. The computer-usable medium of claim 13, wherein:
the monitoring when a user accesses content includes logging user interaction for a specific task or time period according to predetermined scoping parameters.

18. The computer-usable medium of claim 13, wherein:
potential contacts relevant to a current task are recommended as well as general contact recommendations relevant to the content.

19. The computer-useable medium of claim 13, wherein:
the computer executable instructions are deployable to a client computer from a server at a remote location.

20. The computer-useable medium of claim 13, wherein:
the computer executable instructions are provided by a service provider to a customer on an on-demand basis.
